(19) United States
(12) Patent Application Publication
(10) Pub. No.: US 2011/0187654 A1
(43) Pub. Date: Aug. 4, 2011

(54) METHOD AND SYSTEM FOR USER INTERFACE ADJUSTMENT OF ELECTRONIC DEVICE

(75) Inventor: HENG-CHANG LIN, Tu-Cheng (TW)

(73) Assignee: CHI MEI COMMUNICATION SYSTEMS, INC., Tu-Cheng City (TW)

(21) Appl. No.: 12/826,695

(22) Filed: Jun. 30, 2010

(30) Foreign Application Priority Data
Feb. 3, 2010 (TW) 99103258

(51) Int. Cl. G06F 3/041

(52) U.S. Cl. 345/173

(57) ABSTRACT

A system for user interface adjustment includes a touch-enabled display. The touch-enabled display can sense one or more finger contacts to determine a command to adjust the user interface. The command can adjust the size of detectable areas defined by the user interface. The command is executed upon the one or more finger contacts leave the touch-enabled display.

### BACKGROUND

1. Technical Field

Embodiments of the present disclosure relate to user interfaces, and more particularly to capacitive touch panels and a method and system for positioning a graphical keyboard.

2. Description of Related Art

Portable electronic devices such as mobile phones, personal digital assistants (PDAs), and digital cameras are becoming increasingly compact. However, available space on the device for critical input controls is reduced. To solve the problem and enhance operations, replacement of physical controls with “soft” input controls graphically represented on a touch-enabled display has been developed.

Capacitive touch panels are widely employed in portable electronic devices. However, due to their nature, a minimum area is available for component display. In the case of a graphical keyboard application, available space may be insufficient for practical usability.

### BRIEF DESCRIPTION OF THE DRAWINGS

FIG. 1 is a block diagram of one embodiment of a system for user interface adjustment.

FIG. 2 is a flowchart illustrating one embodiment of a method for user interface adjustment.

FIG. 3 is a schematic view of soft keys a graphical keyboard.

FIG. 4 is a schematic view of positioning scaled detectable areas onto original detectable areas.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

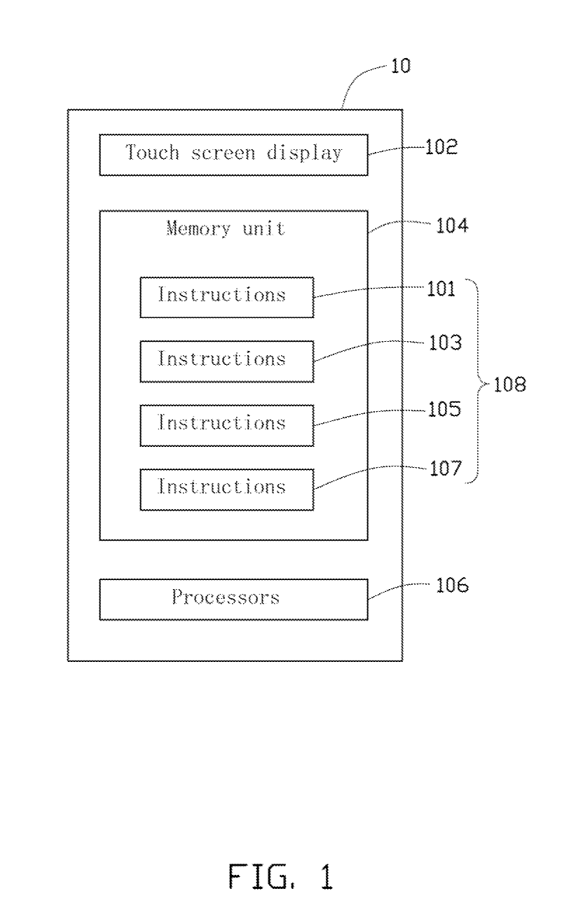

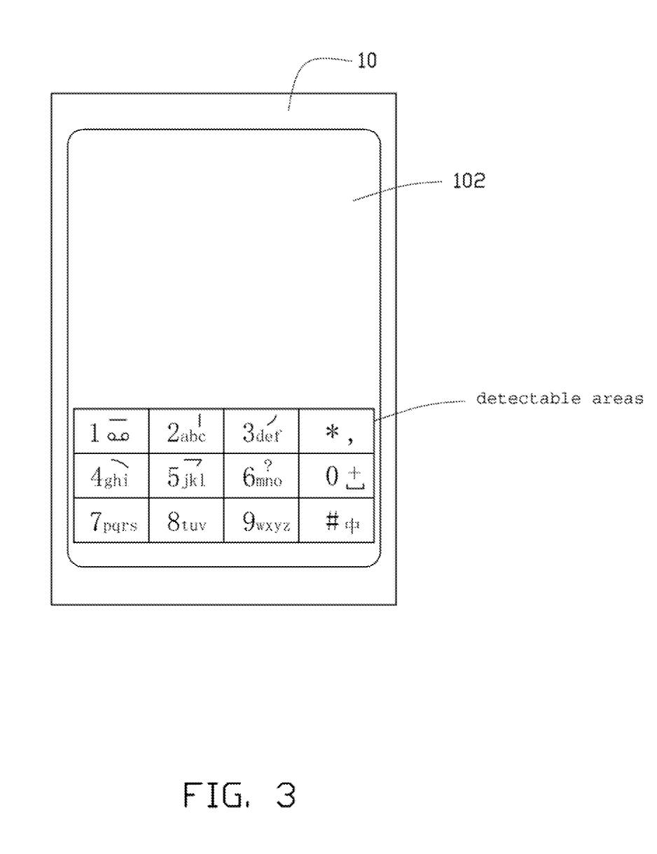

FIG. 1 is a block diagram of a system 10 for user interface adjustment. The system 10 includes a touch-enabled display 102, a memory system 104, one or more processors 106 and one or more programs 108 stored in the memory system 104 and configured to be executed by the one or more processors 106. The one or more programs 108 include instructions 101 for detecting one or more finger contacts with detectable areas on the touch-enabled display 102, instructions 103 for determining a command for the one or more processors with respect to one or more positions of the one or more finger contacts on the one or more graphical keyboards, instructions 105 instructions for adjusting the detectable areas, and instructions 107 for processing the command. Each of the one or more graphical keyboards includes a plurality of soft keys, and the detectable areas are defined as areas covered by soft keys on the one or more graphical keyboards (in FIG. 3).

In one embodiment, the instructions 107 are executed when the one or more finger contacts no longer detected, that is, the command is processed after contact with the touch-enabled display 102 ceases. Commensurately, the instruction 103 can determine the command for different gestures of the one or more finger contacts without actually triggering the command, as long as the one or more finger contacts maintain contact with the touch-enabled display 102. For example, if a contact is detected at a position of a key “P” of the one or more graphical keyboards, the command for the one or more processors is a lower case letter “p”, whereas if a combination of contacts is detected at positions of keys “shift” and “I”, the command is an upper case letter “I”.

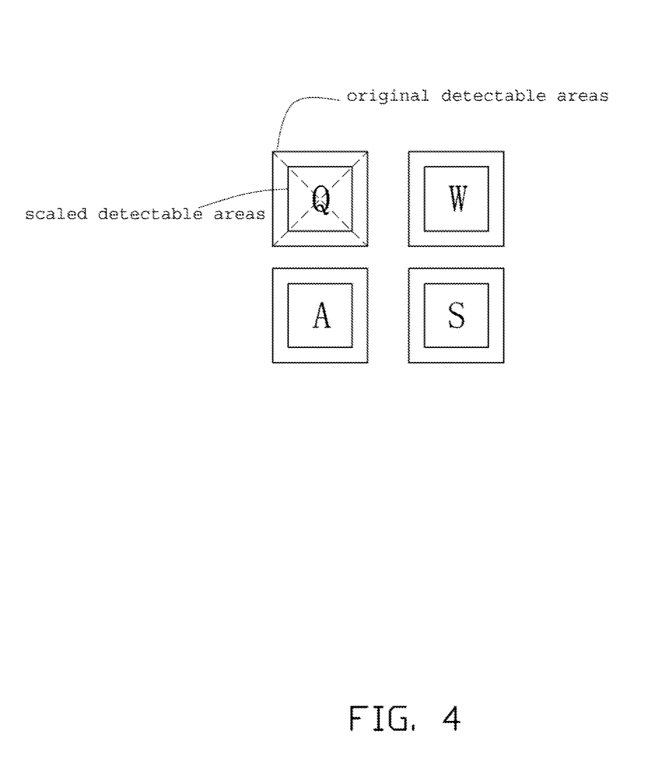

In the embodiment, the instructions 105 include instructions for scaling the detectable areas by one or more predetermined ratios. For example, the one or more predetermined ratios are set to less than 1 for all the detectable areas when the one or more finger contacts are not detected. When the one or more finger contacts are detected, the one or more predetermined ratios are either set to 1 for the detectable areas not detecting the one or more finger contacts or set to greater than 1 for the detectable areas detecting the one or more finger contacts. In addition, the one or more predetermined ratios greater than 1 are set such that the detectable areas detecting the one or more finger contacts are connected with the detectable areas adjacent without overlap. Furthermore, the instructions 105 also include directions for symmetrically positioning the scaled detectable areas onto the original detectable areas (in FIG. 4).

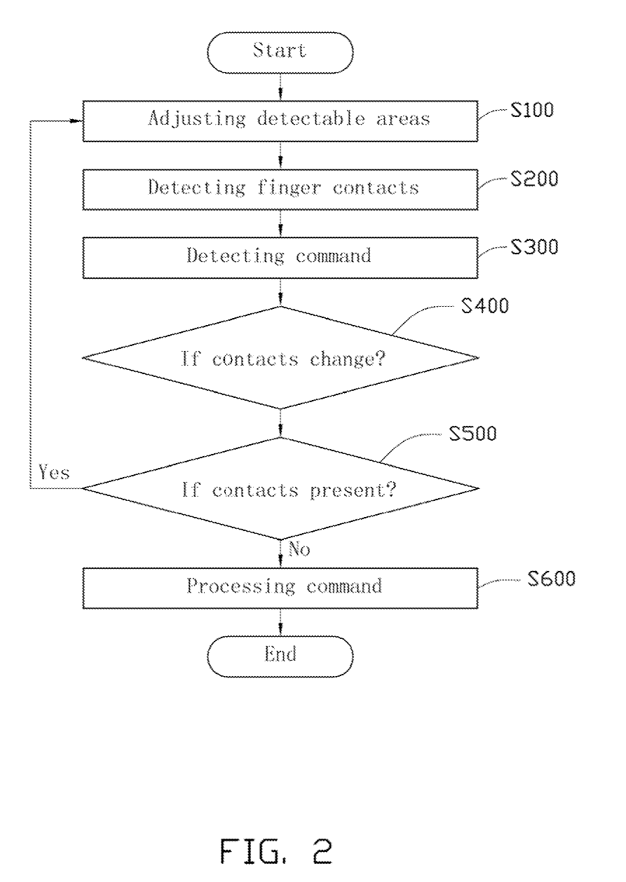

FIG. 2 is a flowchart of one embodiment of a method for positioning for a graphical keyboard on a capacitive touch panel. Depending on the embodiments, additional blocks may be added, others removed, and the ordering of the blocks may be changed.

In block S100, the instructions 105 scale the detectable areas by the one or more predetermined ratios. At first, since the one or more finger contacts are not yet detected on the touch-enabled display 102, the one or more predetermined ratios are set to less than 1 for all the detectable areas. In the embodiment, the one or more predetermined ratios may be either set to 1 or greater than 1 when detection of the one or more finger contacts. The detectable areas detecting the one or more finger contacts are scaled by the one or more predetermined ratios equal to 1 while the detectable areas which didn't detect the one or more finger contacts are scaled by the one or more predetermined ratios greater to 1.

In block S200, the instructions 101 detect the one or more finger contacts with the detectable areas on the touch-enabled display 102. In block S300, the instructions 105 determine the command for the one or more processors 106 with respect to the one or more positions of the one or more finger contacts on the one or more graphical keyboards on the touch-enabled display 102.

In blocks S400 and S500, if the one or more finger contacts change and remain present, that is, the one or more finger contacts are relocated on the touch-enabled display 102, block S100 is repeated. The detectable areas and the command are updated when the one or more finger contacts are relocated on the touch-enabled display 102. If the one or more finger contacts change and no longer appear, block S600 is implemented, in which the one or more processors process the command.

Scaling the detectable areas to be smaller than soft keys on the touch-enabled display 102 increases precision. After one or more finger contacts are present, the detectable areas scale back to the soft key sizes, except for the detectable areas detecting the one or more finger contacts. These areas are scaled to be larger than the soft key sizes to ensure smooth dragging and avoid accidental triggering.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for user interface adjustment, the system comprising:
a touch-enabled display;
a memory system;
one or more processors; and
one or more programs stored in the memory system and configured to be executed by the one or more processors, the one or more programs including:
instructions for detecting one or more finger contacts with detectable areas on the touch-enabled display;
instructions for determining a command for the one or more processors with respect to one or more positions of the one or more finger contacts on the one or more graphical keyboards displayed on the touch-enabled display;
instructions for adjusting the detectable areas; and
instructions for processing the command;
wherein the instructions for processing the command are executed when the one or more finger contacts are no longer detected.

2. The system as claimed in claim 1, wherein each of the one or more graphical keyboards comprises a plurality of soft keys, and the detectable areas are areas covered by the soft keys on the one or more graphical keyboards.

3. The system as claimed in claim 1, wherein instructions for adjusting comprise:
instructions for scaling the detectable areas by one or more predetermined ratios; and
instructions for positioning the scaled detectable areas onto the detectable areas symmetrically.

4. The system as claimed in claim 3, wherein the one or more predetermined ratios are set to less than 1 for all the detectable areas when the one or more finger contacts are not detected.

5. The system as claimed in claim 3, wherein the one or more predetermined ratios are set to:
1 for the detectable areas not detecting the one or more finger contacts; and
greater than 1 for the detectable areas detecting the one or more finger contacts, if the one or more finger contacts are detected.

6. The system as claimed in claim 5, wherein the detectable areas detecting the one or more finger contacts are connected with the detectable areas adjacent thereto.

7. A method for user interface adjustment, the method comprising steps:
detecting one or more finger contacts with detectable areas on the touch-enabled display;
determining a command for one or more processors with respect to one or more positions of the one or more finger contacts on the one or more graphical keyboards displayed on the touch-enabled display;
adjusting the detectable areas; and
processing the command;
wherein the step of processing the command is executed when the one or more finger contacts no longer detected.

8. The method as claimed in claim 7, wherein each of the one or more graphical keyboards comprises a plurality of soft keys, and the detectable areas are areas covered by each soft key on the one or more graphical keyboards.

9. The method as claimed in claim 7, wherein the step of adjusting the detectable areas further comprises:
scaling the detectable areas by one or more predetermined ratios; and
positioning the scaled detectable areas onto the detectable areas symmetrically.

10. The method as claimed in claim 9, wherein the one or more predetermined ratios are set to less than 1 for all the detectable areas when the one or more finger contacts are not detected.

11. The method as claimed in claim 9, wherein the one or more predetermined ratios are set to:
1 for the detectable areas not detecting the one or more finger contacts; and
greater than 1 for the detectable areas detecting the one or more finger contacts,
if the one or more finger contacts are detected.

12. The method as claimed in claim 11, wherein the detectable areas detecting the one or more finger contacts are connected with the detectable areas adjacent thereto.

13. A computer readable storage medium having stored therein instructions, that when executed by a system with a touch-enabled display and one or more processors, cause the system to:
detect one or more finger contacts with detectable areas on the touch-enabled display;
determine a command for the one or more processors with respect to one or more positions of the one or more finger contacts on the one or more graphical keyboards displayed on the touch-enabled display;
adjust the detectable areas; and
process the command;
wherein the operation to process the command are executed when the one or more finger contacts no longer detected.

14. The computer readable storage medium as claimed in claim 13, wherein each of the one or more graphical keyboards comprises a plurality of soft keys, and the detectable areas are areas covered by each soft key on the one or more graphical keyboards.

15. The computer readable storage medium as claimed in claim 13, wherein the operation to adjust the detectable areas further comprises:
to scale the detectable areas by one or more predetermined ratios; and
to position the scaled detectable areas onto the detectable areas symmetrically.

16. The computer readable storage medium as claimed in claim 15, wherein the one or more predetermined ratios are set to less than 1 for all the detectable areas when the one or more finger contacts are not detected.

17. The computer readable storage medium as claimed in claim 15, wherein the one or more predetermined ratios are set to:
1 for the detectable areas not detecting the one or more finger contacts; and
greater than 1 for the detectable areas detecting the one or more finger contacts,
if the one or more finger contacts are detected.

18. The computer readable storage medium as claimed in claim 17, wherein the detectable areas detecting the one or more finger contacts are connected with the detectable areas adjacent thereto.
